(19) United States
(12) Patent Application Publication
(10) Pub. No.: US 2016/0288112 A1
(43) Pub. Date: Oct. 6, 2016

(54) CATALYST FOR EXHAUST GAS PURIFICATION

(71) Applicant: Johnson Matthey Catalysts (Germany) GmbH, Redwitz an der Rodach (DE)

(72) Inventors: Juergen BAUER, Redwitz (DE); Diana BISKUPSKI, Redwitz (DE); Ralf DOTZEL, Redwitz (DE); Joerg Walter JODLAUK, Werschweiler (DE); Rainer LEPPELT, Redwitz (DE); Joerg Werner MUENCH, Redwitz (DE); Irene PIRAS, Redwitz (DE); Johannes SCHU, Redwitz (DE); Gudmund SMEDLER, Vastra Frölunda (SE)

(21) Appl. No.: 15/086,227

(22) Filed: Mar. 31, 2016

(30) Foreign Application Priority Data
Mar. 31, 2015 (DE) 102015205843.3

(51) Int. Cl. B01J 35/00; B01J 21/16; B01J 35/04

(52) U.S. Cl. CPC B01J 35/002; B01J 35/04; B01J 21/16

(57) ABSTRACT

A honeycomb catalyst for exhaust gas purification comprising a honeycomb body, the honeycomb body comprising: a fraction acting as a pollutant trap and/or having a catalytically active fraction based on a catalytically active system comprising a base metal; and a catalytically inactive fraction, wherein the catalytically inactive fraction comprises at least one thermally stable sulphate or sulphide component for reducing thermally induced shrinkage of the honeycomb body.

### CROSS REFERENCE TO RELATED APPLICATION

This application claims priority benefit to German Application No. 102015205843.3, filed on Mar. 31, 2015, which is incorporated herein by reference.

The invention relates to a catalyst for exhaust gas purification, especially for exhaust gas purification of exhaust gases from motor vehicles.

A wide variety of catalysts which are in each case matched to the specific application are generally known for exhaust gas purification, depending on the field of use. For exhaust gas purification in motor vehicles, use is frequently made of ceramic honeycomb catalysts through which the exhaust gas flows during operation. These catalysts are frequently extruded ceramic bodies. They usually have a circular cross section. The catalysts are typically exposed to elevated temperatures in the range 400-700° C. during operation.

The catalyst serves, inter alia, for reduction of nitrogen oxides, for example. For this purpose, in particular the selective catalytic reduction (SCR) process which is known per se can be used. In this process, nitrogen oxides are reduced to nitrogen in the presence of a nitrogenous reductant, typically ammonia, and oxygen. Various SCR catalyst types and systems are known in principle for accelerating this reaction.

Other exhaust gas purification systems promote the oxidation of carbon monoxide to carbon dioxide and the oxidation of unburnt hydrocarbons to water (vapour) and carbon monoxide or the cyclic adsorption of nitrogen oxides (NOx) from an exhaust gas from a lean-burn engine, followed by desorption and reduction of NOx in a hydrocarbon-rich exhaust gas (the so-called NOₓ trapping process, which uses a specially formulated catalyst referred to as a NOₓ trap or NOₓ adsorber catalyst (NAC)). If the motor vehicle engine is controlled to at least approximately stoichiometric operation, simultaneous catalytic oxidation of carbon monoxide and unburnt hydrocarbons and also reduction of nitrogen oxides can be effected by a three-way catalyst.

In addition to these common general knowledge catalysts for exhaust gas purification of exhaust gases from motor vehicles, there are also known combined catalysts in which a filter action is combined with a catalytic action. For this purpose, use is made of, for example, preferably wall flow filters which have been catalytically activated. Wall flow filters are honeycomb filters which comprise a honeycomb body having an arrangement of porous walls, with the walls defining an array of parallel first and second channels extending in the longitudinal direction. The first channels are closed at a first end of the honeycomb body and the second channels are closed at a second end of the honeycomb body. A specific field of application here is catalysed soot filters (CSF), which are used, in particular, for the automobile sector for oxidising carbon monoxide, unburned hydrocarbons and particulate matter.

An established catalyst class especially for an SCR catalyst is based on an in particular oxidic titanium-vanadium system (e.g. V₂O₅/TiO₂ or V₂O₅/WO₃/TiO₂), having vanadium oxide as catalytically active component in a titanium oxide support material. This titanium-vanadium system can be generally assigned to a catalyst class based on a base metal; here vanadium.

In addition, there are catalyst systems based on noble metals and especially also catalyst systems based on catalytically active or activated crystalline molecular sieves, in particular zeolites, i.e. aluminosilicate crystalline molecular sieves. These often comprise a promoter metal from the group of the base metals for the catalytic activation. In the automotive art, the promoter metal is typically copper or iron.

The catalysts used in motor vehicles today are based predominantly on ceramic honeycomb catalysts. During operation, the exhaust gas to be purified flows through channels of a, for example, extruded catalyst body. Here, an in-principle distinction is made here between an extruded ceramic honeycomb catalyst and coated supports, known as “washcoats”. In the case of extruded ceramic honeycomb catalyst, a catalytically active catalyst composition forms the extruded body, i.e. the channel walls of the catalyst are formed of a catalytically active material. In the case of washcoats, a catalytically inert extruded support body is coated with the actual catalytically active catalyst material. This is effected, for example, by dipping the extruded support body into a suspension containing the catalyst material.

To produce both an extruded ceramic honeycomb catalyst and an inert support body, ceramic starting components, which are usually present in powder form, are mixed with one another and processed to give a ceramic composition. In the case of extruded bodies, this then usually paste-like composition is extruded to produce a honeycomb body. The “green” body obtained in this way is subsequently subjected to heat treatment in order to form the final ceramic body.

Catalytically inactive components, for example binders or fillers, are generally necessary to produce an extruded ceramic honeycomb catalyst in order to set suitable mechanical properties of the ceramic body. These catalytically inactive components are usually clays or alumina. To increase the mechanical strength, fibres, in particular glass fibres, are frequently added. Sinter bridges are generally formed via the binder fractions during sintering of the ceramic catalyst composition, and these are important for imparting stiffness and intrinsic stability to the final catalyst.

In the motor vehicle sector, extruded ceramic honeycomb catalysts and washcoated supports, in particular an extruded ceramic honeycomb catalyst, are usually arranged in a tube-like cylindrical housing, and are pressed in with interposition of a heat-resistant fibre mat. The fixing of the catalyst within the housing is frequently effected exclusively by the pressing-in forces and holding forces exercised by the fibre mat.

Ceramic honeycomb catalysts, in particular extruded ceramic honeycomb catalysts, display thermally induced shrinkage which, in particular, also increases noticeably as a result of the thermal stresses during use. This thermal or age-related shrinkage is particularly noticeable at the elevated operating temperatures at which the catalysts are used in exhaust gas purification.

However, excessive shrinkage leads to the problem that the holding forces within the catalyst housing decrease and the catalyst is thus under some circumstances no longer held sufficiently firmly within the housing. Even a shrinkage of about 0.5% or greater is undesirable here. The unsatisfactory fixing of the catalyst can then lead to problems and to damage to the catalyst or to the exhaust gas system during further operation. Apart from, for example, increased mechanical stressing of the catalyst due to vibrations and undesirable noise emissions associated therewith, there is also the danger that the catalyst will be pushed out of the tube-like housing in which it is arranged.

Proceeding therefrom, it is an object of the invention to avoid, as far as possible, such a loosening of a catalyst within a housing as a result of ageing-related shrinkage of the ceramic catalyst body.

The object is achieved, according to the invention, by a honeycomb catalyst for exhaust gas purification comprising a honeycomb body, the honeycomb body comprising: a fraction acting as a pollutant trap and/or having a catalytically active fraction based on a catalytically active system comprising a base metal; and a catalytically inactive fraction, wherein the catalytically inactive fraction comprises at least one thermally stable sulphate or sulphide component for reducing thermally induced shrinkage of the honeycomb body.

The catalyst preferably serves for exhaust gas purification and is, in particular, preferably configured as an SCR catalyst. For the present purposes, a catalyst is the shaped ceramic body which has a catalytic activity specifically for the desired exhaust gas purification. In particular, the catalyst is a catalyst composed, for example, of an extruded ceramic honeycomb catalyst in which the total volume of the ceramic body displays catalytic activity.

The catalyst thus comprises a shaped ceramic body having a catalytically inactive fraction and a catalytically active fraction. A system based on a base metal, in particular with vanadium as catalytically active component, is used as catalytically active system for the catalytically active fraction. The catalytically inactive fraction further comprises at least one thermally stable component for reducing thermally induced shrinkage of the catalyst. This component for reducing the shrinkage is a sulphate or a sulphide which is thermally stable and counters thermally induced shrinkage. The component is therefore added as a thermally stable additive.

The invention proceeds from the idea of reducing the ageing-related shrinkage of the catalyst by means of suitable modification of the composition of the shaped ceramic body of the catalyst in the case of a shaped catalyst body having a base metal system as catalytically active component. For the present purposes, thermally stable means that the components withstand temperatures of at least 600° C. and preferably at least 800° C. in the long term without volatilizing or transforming and without their properties changing significantly.

Studies have shown that the addition of such components selected from the group consisting of sulphates and sulphides can lead to a significant reduction in the ageing-related shrinkage. In this way, it is ensured that the catalyst is permanently held firmly in the housing in which it is pressed in with the aid of a mat.

The catalytically active fraction comprises, in particular, a vanadium oxide/metal oxide fraction having vanadium oxide as catalytically active component in a metal oxide support material selected from the group consisting of aluminium, titanium, zirconium, cerium, silicon and combinations thereof.

As an alternative, the catalytically active fraction contains a crystalline molecular sieve, in particular an aluminosilicate which is provided with a base promoter metal. Preferred molecular sieves are so-called small-pore molecular sieves which have a tetrahedral ring-opening structure having a maximum of 8 atoms. Medium-pore molecular sieves such as FER or MFI having a tetrahedral ring-opening structure having a maximum of 10 atoms or else large-pore molecular sieves such as BEA or MOR (having a tetrahedral ring-opening structure having a maximum of 12 atoms) can likewise be advantageously used for the purposes of the invention. Preferred small-pore molecular sieves include ones which have a framework type having the CHA, AEI or ASX framework type code. The base metal for the promoter is preferably copper and/or iron, which can be introduced by ion exchange into the lattice structure of the molecular sieve.

The catalyst preferably comprises a vanadium-titanium catalyst having a vanadium-titanium system as active fraction. Preference is given to using vanadium pentoxide or a combination of vanadium pentoxide with tungsten oxide as catalytically active component. In particular, V₂O₅/TiO₂ or V₂O₅/WO₃/TiO₂ is used as catalytically active fraction. As an alternative to or in addition to vanadium pentoxide, vanadium-iron compounds are used as catalytically active components, in particular iron vanadate (FeVO₄) and/or iron aluminium vanadate (Fe_{0.8} Al_{0.2}VO₄).

The vanadium-based systems are, in particular, titanium-vanadium-tungsten systems (V₂O₅/WO₃/TiO₂), titanium-vanadium-tungsten-silicon systems or titanium-vanadium-silicon systems or mixtures thereof. The vanadium-iron compounds are, in particular, titanium-vanadium-tungsten-iron systems, titanium-vanadium-tungsten-silicon-iron systems or titanium-vanadium-silicon-iron systems or mixtures thereof.

In the vanadium oxide/metal oxide systems, the active catalytic fraction, i.e. the proportion of the vanadium oxide/metal oxide system, is from 70 to 90% by weight. The remainder is made up by the inactive fraction. These are overall binder fractions, for example clays and/or alumina, inorganic reinforcing fibres, for example glass fibres, and stabilizers. The proportions indicated here and below are in each case, unless explicitly indicated otherwise, proportions by weight based on a dry ceramic composition from which the ceramic body is then produced, for example by extrusion and sintering. For the present purposes, the term dry ceramic composition refers to the proportions by weight of the individual components in the pulverulent starting state.

In an alternative variant of the catalytic system based on a base metal, a tungsten oxide-cerium oxide system or a stabilized tungsten oxide-cerium oxide system (WO₃/CeO₂) is used for the catalytically active fraction.

In addition to the vanadium-titanium SCR catalyst, the catalyst can also comprise a mixture of the vanadium-titanium SCR catalyst and a crystalline molecular sieve, in particular an aluminosilicate zeolite, having a base promoter metal. The molecular sieve can be one of the abovementioned small-, medium- or large-pore molecular sieves.

Usefully, the thermally stable component according to the invention, i.e. the sulphateor the sulphide, is selected so that it additionally serves as promoter for improving the catalytic activity of the catalytic fraction and thus of the catalyst as such. For the purposes of the present invention, promoters are generally substances and components which increase the effectiveness of the catalyst, but without being catalytically active themselves. That is they do not contribute to the 70 to 90% by weight active catalytic fraction calculation hereinabove.

Apart from the improvement in respect of the ageing-related shrinkage, this measure at the same time produces an improvement in the catalytic activity. A double effect is thus achieved in this way.

Particularly when using sulphur-based thermally stable components, such a promoter effect is obtained, in particular, in combination with a titanium-vanadium-based catalyst system.

Loading of the catalyst with sulphur gives overall a better degree of NOx conversion. This is of particular importance in the automobile sector in which only very low-sulphur or sulphur-free fuels are used nowadays, so that sulphur loading of the catalyst from the exhaust gas no longer occurs, or no longer occurs to a sufficient extent to provide a promoting effect. As a result of the sulphates or sulphides used, acidic sites are therefore incorporated, and these have a positive effect on the catalytic activity of the catalytically active components, in particular of the vanadium in the case of a titanium-vanadium system.

Preferably, an alkali metal sulphate, an alkaline earth metal sulphate, a metal sulphate or a sulphate of a transition metal is used as thermally stable component. These sulphates display particularly good, in particular thermal, stability and are therefore particularly suitable for use in a catalyst which is subject to high thermal stress. In addition, they also act as promoter and therefore aid the catalytic activity.

The thermally stable component is usefully selected from the group consisting of a calcium sulphate (CaSO₄), a barium sulphate (BaSO₄), a lithium sulphate (LiSO₄) and a titanium oxide sulphate (TiO(SO₄)) and mixtures of two or more of these sulphates.

Preference is given to using, in particular, calcium sulphate. In the case of this, not only good ageing stability in respect of the shrinkage behaviour but also improved catalytic activity has been found to a particularly significant extent. Particularly in the case of calcium sulphate, it is assumed that the good values in respect of the ageing-related shrinkage are attributable to the shrinkage of the further customary ceramic components being at least partly compensated for by expansion of the calcium sulphate on heating.

It is useful to use one or more sulphides in addition or alternatively as thermally stable component. In particular, an alkali metal sulphide, an alkaline earth metal sulphide, a metal sulphide or a sulphide of a transition metal is used. Here too, as in the case of the sulphates, these display particularly good thermal stability and also additionally act as promoter.

Preferably, a sheet silicate, particularly mica, is used in addition to the sulphate or sulphide thermally stable component. Studies have shown that significant improvements in the ageing-related shrinkage are achieved by the use of mica in combination with the sulphate or sulphide thermally stable component.

Preferably, a combination of: (i) at least two thermally stable sulphate components; (ii) at least two thermally stable sulphide components; or (iii) at least one thermally stable sulphate component and at least one thermally stable sulphide component is used. This mixing of a plurality of thermally stable components enables, in an appropriate way, a particularly good value for the ageing-related shrinkage to be achieved and at the same time a high catalytic activity due to the use of a suitable promoter also to be achieved.

A combination of mica with one or more sulphates, in particular selected from the group consisting of calcium sulphate, barium sulphate and titanium oxide sulphate (TiO(SO₄)), has been found to be particularly suitable. In particular, a combination of mica and calcium sulphate is preferred.

The weight ratio of these two components, i.e. mica to at least one of the components selected from the group consisting of calcium sulphate, barium sulphate and titanium oxide sulphate, is in the range from 1:2 to 2:1. The weight ratio is preferably about 1:1. The two components are therefore preferably present approximately in an equal weight ratio.

The total proportion of the thermally stable component, and in the case of the use of a plurality of thermally stable components the total proportion of these, is in the range from 2 to 10% by weight based on the dry ceramic composition as defined at the outset. In particular, the proportion is approximately in the range from 6 to 8% by weight.

In the case of the vanadium-titanium systems which are of particular interest here, the total proportion of the ceramic inactive components, i.e. the ceramic inactive fraction, is in the range from 10 to 30% by weight. Thus, for example, a quarter to a third of the inactive fraction is therefore provided by the thermally stable component.

The fibre fraction which is otherwise frequently present is usefully replaced at least partly by the at least one thermally stable component. In the case of complete replacement, a fibre fraction is then no longer present.

Furthermore, the at least one thermally stable component is, advantageously, homogeneously distributed in the volume of the catalyst. Thus, it is not only introduced on the surface or in the region close to the surface by impregnation, but is instead present in the entire composition. It is therefore mixed with all other ceramic components during production of the catalyst, i.e. during formation of the catalyst composition from which the ceramic body is then produced.

The honeycomb catalyst according to the invention is an extruded catalyst. For the purposes of the present invention, this means that the body of the catalyst has been produced by an extrusion process. This body can be an extruded ceramic honeycomb catalyst or else an inert ceramic body having a coating applied thereto in the manner of a washcoat. In both cases, the thermally stable component is present in the ceramic body. However, preference is given to an extruded ceramic honeycomb catalyst in which the catalytically active fraction is distributed in the volume.

In the finished state, the catalyst is usefully pressed in within a catalyst housing, known as a can, with the aid of an embedding mat. The catalyst is, for later use, typically installed within a motor vehicle, for example within a goods vehicle or passenger car in the exhaust gas train.

The catalyst comprises, in particular, a catalyst for the reduction of nitrogen oxides (SCR catalyst). However, the invention is not restricted to such catalysts. The catalyst can in principle also be used as wall flow filter, for example a wall flow filter having the construction described hereinabove and comprising an SCR catalyst, an oxidation catalyst, i.e. for use as a CSF catalyst, a three-way catalyst for use as a gasoline soot filter, etc. The fraction of the catalyst acting as pollutant trap is preferably provided by a fraction as trap for hydrocarbons (hydrogen trap) or as trap for nitrogen oxides. The fraction for forming the hydrocarbon trap is used, for example, by a crystalline molecular sieve, for example an aluminosilicate zeolite of the MFI or the FAU framework type. The hydrocarbon trap activity can also optionally be improved by a palladium and/or silver promoter metal. Furthermore, in one variant, the catalyst body consists of a plurality of subregions which differ in respect of their catalytic functionality in an intended flow direction of the exhaust gas.

Non-limiting Examples of the invention are illustrated below with reference to the accompanying drawings, in which:

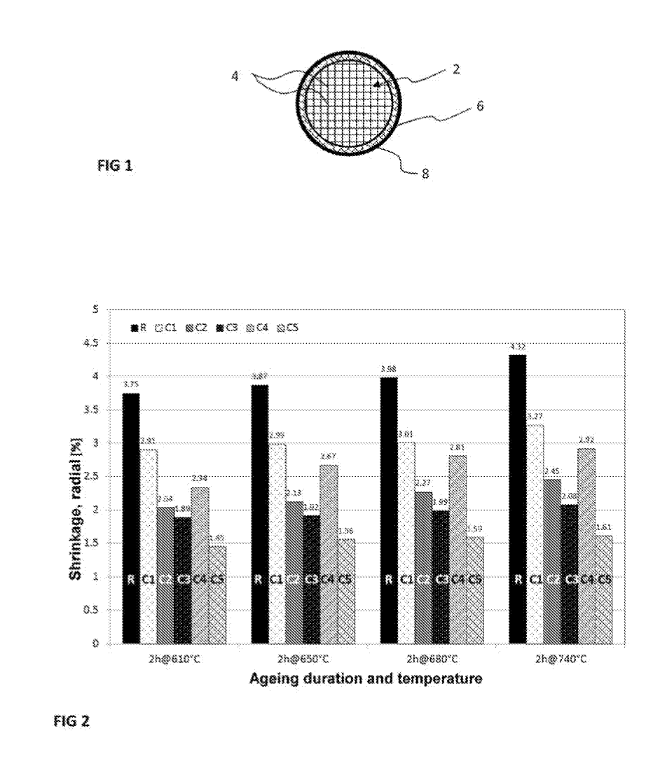

FIG. 1 is a schematic simplified cross-sectional depiction of an extruded honeycomb catalyst pressed into a catalyst housing; and

FIG. 2 is a graph comparing the shrinkage of the catalyst when different thermally stable components are used.

Firstly, FIG. 1 illustrates the typical field of use of the catalyst 2 which is of interest here. The catalyst 2 is an extruded catalyst based on a vanadium-titanium catalyst system. In particular, it is an extruded ceramic honeycomb catalyst in which the volume of the catalyst 2 is formed by a catalytically active composition. The catalyst 2 configured as honeycomb catalyst has flow channels 4 which run in the longitudinal direction and through which the exhaust gas to be purified flows during operation. The walls of the catalyst 2 are generally porous, so that the exhaust gas can penetrate into the active material of the catalyst and the appropriate catalytic reaction takes place there.

The catalyst 2 preferably has a circular cross-sectional area and is pressed into a tubular housing 6 with interposition of an embedding mat configured as fibre mat 8. Further mechanical or other fastening elements are, in particular, not present. The catalyst 2 is therefore preferably held within the catalyst housing 6 exclusively by the fibre mat 8. In view of this background, it is particularly important that the catalyst 2 remains dimensionally stable over the entire time of operation and does not shrink to an excessive extent (Δd/d, where d is a longitudinal dimension, in particular the diameter of the catalyst 2). Δd is the change in this dimension compared to an initial state. If the shrinkage is, for example, greater than 0.5% compared to the initial state, this would lead to loosening of the seating of the catalyst 2 within the housing 6.

The housing 6 with the catalyst 2 is, during operation, integrated into an exhaust gas train, in particular of a motor vehicle, i.e. an exhaust gas inlet line and an exhaust gas outlet line are connected at the end faces to the housing 6 and an exhaust gas flows through the housing 6 and therefore the catalyst 2 during operation.

The catalyst is, as mentioned above, a titanium-vanadium catalyst, in particular an oxidic titanium-vanadium system. The weight ratio of titanium dioxide to vanadium pentoxide (TiO₂/V₂O₅) is typically in the range from 20 to 75. The titanium-vanadium system overall forms the active fraction of the catalyst. It has a proportion by weight of from 70 to 90%. In the present case, tungsten oxide (WO₃) is preferably additionally used. The proportion of the titanium dioxide is, for example, in the range from about 70 to 75% by weight, that of tungsten oxide is in the range from 8 to 12% by weight and that of vanadium pentoxide is in the range from 1.5 to 3% by weight. These three components form, preferably exhaustively without further catalytically active components, the active fraction.

In addition, the catalyst comprises from about 6 to 10% of inorganic binders and fillers, in particular suitable clays, as inactive fraction. The catalyst additionally comprises, if required, inorganic fibres, for example glass fibres which typically have a diameter in the range from a few μm, in particular about 6-10 μm. In a comparative catalyst without addition of the thermally stable components, the proportion of glass fibres is in the range from 6 to 10% by weight and in particular about 8% by weight. This fibre fraction is preferably at least partly replaced by the thermally stable components which are described in more detail below.

Starting out from the comparative catalyst, designated as reference R below, the glass fibre fraction was replaced by mica and/or by calcium sulphate in different ratios to form various catalysts C1 to C5, as can be seen from Table 1 below, with C4 and C5 being according to the invention:

TABLE 1

| Component | R | C1 | C2 | C3 | C4 | C5 |
|---|---|---|---|---|---|---|
| V₂O₅/TiO₂/WO₃ | 84.5 | 84.5 | 84.5 | 84.5 | 84.5 | 84.5 |
| [% by weight] | | | | | | |
| Clays | 7.5 | 7.5 | 7.5 | 7.5 | 7.5 | 7.5 |
| [% by weight] | | | | | | |
| Glass fibres | 8.0 | 4.0 | 2.0 | 0 | 4.0 | 0 |
| [% by weight] | | | | | | |
| Mica | — | 4.0 | 6.0 | 8.0 | 0 | 4.0 |
| [% by weight] | | | | | | |
| CaSO₄ | — | 0 | 0 | 0 | 4.0 | 4.0 |
| [% by weight] | | | | | | |

As can be seen, the reference catalyst R comprises vanadium pentoxide, titanium dioxide and tungsten oxide in a total proportion by weight of 84.5% by weight as active fraction. In addition, it comprises clays in a proportion by weight of 7.5% by weight and glass fibres in a proportion by weight of 8.0% by weight as inactive fraction. Within the active fraction, the titanium dioxide has a proportion by weight of about 72.7% by weight and the tungsten oxide has a proportion by weight of 10% by weight. The vanadium pentoxide has a proportion by weight of about 1.7% by weight.

In the catalyst C1, half of the glass fibre fraction was replaced by mica, in the catalyst C2 about three quarters of the glass fibre fraction was replaced by mica and in the catalyst C3 all of the fibre fraction was replaced by mica. In the case of the catalyst C4, finally, half of the fibre fraction was replaced by calcium sulphate and in the catalyst C5 all of the fibre fraction was replaced by a combination of equal weights of mica and calcium sulphate.

In principle, the fibre fraction can also be retained. The critical factor is the additional mixing-in of the thermally stable component.

In FIG. 2, the properties of these catalysts C1-C5 are compared with one another and the reference catalyst R in respect of shrinkage in the radial direction (shrinkage) Δd/d in a bar graph, where d is a dimension for the radial direction, in particular the diameter in a cylindrical catalyst. In order to reproduce thermally induced ageing, the catalysts were exposed to elevated temperatures of 610° C., 650° C., 680° C. and 740° C. for two hours. To determine the shrinkage Δd/d, the volume of the catalyst C2 was determined before and after this thermal treatment.

As can be seen from the graph in FIG. 2, the reference catalyst R displays a shrinkage Δd/d in the range from about 3.75% to 4.32%, depending on the temperature. This shrinkage is reduced significantly to about 3% in the case of the catalyst C1, i.e. by replacement of half of the fibre fraction by mica. An increase in the proportion of mica in the case of the catalyst C2 leads to a further significant reduction in the shrinkage. Total replacement of the fibre fraction by mica in the case of the catalyst C3 leads to an additional improvement. Overall, a reduction in the shrinkage by half compared to the reference catalyst R can be achieved by the use of mica.

As the data for the catalyst C4 according to the invention show, a slightly better effect in respect of the shrinkage is achieved when calcium sulphate is used instead of mica. Here, the catalyst C4 is to be compared with the catalyst C1. In both cases, half of the fibre fraction was replaced by mica or calcium sulphate, respectively.

A significant improvement in the shrinkage values is then obtained for a combination of mica with calcium sulphate in the case of the catalyst C5. The fibre fraction is in this case replaced completely by half of the respective amount of mica and calcium sulphate. As can be seen from FIG. 2, the shrinkage is in this way reduced significantly again to virtually one third of the values of the reference catalyst R.

Table 2 below additionally shows, finally, the effect of various thermally stable components as promoter in respect of the catalytic activity, measured here as degree of conversion of NOx. The table shows the degree of conversion of NOx in percent as a function of the temperature in degrees Celsius. Under identical experimental conditions, the respective catalyst was supplied with an identical test gas having a defined NOx content at identical flow velocities, etc. The residual content of the nitrogen oxides downstream of the catalyst is measured and the degree of conversion of NOx is calculated therefrom by comparison with the nitrogen oxide contents upstream of the catalyst.

TABLE 2

| | NOx conversion (at temperature [° C.]) | | | | | |
|---|---|---|---|---|---|---|
| | Temp. [° C.] | | | | | |
| Cat | 180 | 215 | 250 | 300 | 400 | 500 |
| R | 27.8 | 54.0 | 73.4 | 86.5 | 91.5 | 78.1 |
| C6 60 g | 39.7 | 65.4 | 79.2 | 86.4 | 87.0 | 70.2 |
| TiO(SO4) | | | | | | |
| C7 30 g | 32.2 | 55.7 | 71.9 | 83.3 | 86.9 | 70.4 |
| TiO(SO4) | | | | | | |
| C8 30 g | 30.1 | 55.0 | 71.5 | 82.2 | 86.5 | 70.5 |
| CdSO4 | | | | | | |
| C9 15 g | 40.0 | 66.6 | 81.5 | 90.6 | 94.2 | 80.6 |
| BaSO4 | | | | | | |
| C10 TiW plus | 40.7 | 66.7 | 82.1 | 91.7 | 93.6 | 72.8 |
| 4% CaSO4 | | | | | | |

The individual values were once again measured relative to the same reference catalyst R as described above. This was compared with further catalysts C6 to C10 which have the identical composition and the identical proportion by weight of the active fraction but differ in respect of the composition of the inactive fraction (as per Table 3 below). Table 3 shows only some components of the inactive fraction; in particular, the proportion of clays in an amount of 7.5% by weight, which is identical for all catalysts R, C6-C10, is absent.

TABLE 3

| Component | R | C6 | C7 | C8 | C9 | C10 |
|---|---|---|---|---|---|---|
| Glass fibres | 8.0 | 6.0 | 7.0 | 7.0 | 7.5 | 7.7 |
| [% by weight] | | | | | | |
| TiO(SO4) | — | 2.0 | 1.0 | — | — | — |
| [% by weight] | | | | | | |
| CdSO4 | — | — | — | 1.0 | — | — |
| [% by weight] | | | | | | |
| BaSO4 | — | — | — | — | 0.5 | — |
| [% by weight] | | | | | | |
| CaSO4 | — | — | — | — | — | 3.8 |

In the case of the catalysts C6 to C10, a particular proportion of the glass fibres was in each case replaced by the thermally stable component titanium oxide sulphate (catalysts C6 and C7), cadmium sulphate (catalyst C8) or barium sulphate (catalyst C9). In the case of the catalyst C10, in contrast an additional proportion of calcium sulphate was additionally added to the mixture of the reference catalyst R; this additional proportion corresponds to 4% by weight of the mixture of the reference catalyst R. In total, the percentages by weight based on the altered composition have shifted somewhat to the value indicated in Table 3.

As can be seen from Table 3, the compositions comprising calcium sulphate, barium sulphate or titanium oxide sulphate display particularly positive effects in respect of the degree of conversion of NOx. Compared to the reference catalyst R, these thermally stable additives all give significantly improved degrees of conversion compared to the reference catalyst R in the lower temperature range up to about 300° C. In the case of the additives calcium sulphate and also barium sulphate, this also applies for higher temperatures. The addition of barium sulphate, in particular, enables improved degrees of conversion to be achieved over the total temperature spectrum.

In summary, an addition of a combination of mica with barium sulphate or calcium sulphate is therefore particularly preferred since a high reduction in the ageing-related shrinkage together with a simultaneous improvement in the catalytic activity is achieved thereby. The proportions by weight of the sulphates used are preferably in the range from 3 to 5% and in particular about 4%. The proportion of mica is approximately in the same range. The proportion of the inorganic fibres is preferably, but not necessarily, reduced by the introduction of these additives.

### LIST OF REFERENCE NUMERALS

2 Catalyst
4 Flow channels
6 Housing
8 Fibre mat

1. A honeycomb catalyst for exhaust gas purification comprising a honeycomb body, the honeycomb body comprising: a fraction acting as a pollutant trap and/or having a catalytically active fraction based on a catalytically active system comprising a base metal; and a catalytically inactive fraction, wherein the catalytically inactive fraction comprises at least one thermally stable sulphate or sulphide component for reducing thermally induced shrinkage of the honeycomb body.

2. The honeycomb catalyst according to claim 1, which comprises a vanadium oxide/metal oxide catalyst in which the catalytically active fraction contains vanadium oxide as catalytically active component supported on a metal oxide support material.

3. The honeycomb catalyst according to claim 1, which comprises a crystalline molecular sieve having a promoter based on a base metal.

4. The honeycomb catalyst according to claim 1, wherein the thermally stable component is an alkali metal sulphate, an alkaline earth metal sulphate, a metal sulphate or a sulphate of a transition metal.

5. The honeycomb catalyst according to claim 1, wherein the thermally stable component is selected from the group consisting of lithium sulphate (LiSO₄), calcium sulphate (CaSO₄), barium sulphate (BaSO₄), and TiO(SO₄).

6. The honeycomb catalyst according to claim 1, wherein the thermally stable component is calcium sulphate.

7. The honeycomb catalyst according to claim 1, wherein the thermally stable component is an alkali metal sulphide, an alkaline earth metal sulphide, a metal sulphide or a sulphide of a transition metal.

8. The honeycomb catalyst according to claim 1, comprising a combination of: (i) at least two thermally stable sulphate components; (ii) at least two thermally stable sulphide components; or (iii) at least one thermally stable sulphate component and at least one thermally stable sulphide component.

9. The honeycomb catalyst according to claim 1, comprising a sheet silicate.

10. The honeycomb catalyst according to claim 9, wherein the sheet silicate is a mica.

11. The honeycomb catalyst according to claim 10, comprising mica and at least one thermally stable component selected from the group consisting of CaSO₄, BaSO₄ and TiO(SO₄).

12. The honeycomb catalyst according to claim 11, wherein the weight ratio of mica to the at least one thermally stable component is in the range of from 1:2 to 2:1.

13. The honeycomb catalyst according to claim 1, wherein the proportion of the at least one thermally stable component is from 2 to 10% by weight.

14. The honeycomb catalyst according to claim 1, wherein the at least one thermally stable component is homogeneously distributed in the volume of the honeycomb body.

15. The honeycomb catalyst according to claim 1, wherein the honeycomb body is an extruded catalyst (2).

16. The honeycomb catalyst according to claim 1, which has been pressed in within a housing with the aid of an embedding mat.
